(19) United States
(12) Patent Application Publication
(10) Pub. No.: US 2006/0181507 A1
(43) Pub. Date: Aug. 17, 2006

(54) Apparatus for generating exact vertical or horizontal motion-with a dual-axis input device

(76) Inventors: David Kulczar, Austin, TX (US); Leonel Saenz III, Austin, TX (US); Thanh K. Tran, Austin, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(21) Appl. No.: 11/060,604

(22) Filed: Feb. 17, 2005

(51) Int. Cl. G09G 5/00

(52) U.S. Cl. 345/156

(57) ABSTRACT

A user of a two-axis input device has the capability to automatically construct a vertical or horizontal line. The input device has a mechanical means that the user can implement to inhibit inputs submitted from either the X-axis or the Y-axis to the computer. As a result, the computer only receives inputs from the axis in the direction for which the user desires to draw the straight line.

### FIELD OF THE INVENTION

This invention relates to an apparatus that will provide assistance to user attempting to generate straight lines on a display screen and in particular this invention relates to an apparatus that can alter the vertical and horizontal inputs of the dual-axis device such that only inputs from either the X or Y axis resulting in inputs from only one axis and a resulting line having only coordinates from that one axis.

### BACKGROUND OF THE INVENTION

All computer systems incorporate some type of input device through which the user communicates with the computer. Input devices send information and instructions to the central processor unit (CPU) of the computer. Some of these devices are hand-operated, but others work automatically once the user turns them on. Once such device is the computer mouse. The mouse is a palm-sized device that the computer user moves about on a flat surface. This device has two functions: 1) to move the insertion point and 2) to give commands to the computer. Computer users commonly operate the mouse on a smooth sheet of plastic or rubber known as a mouse pad. A standard mouse device contains a ball built into the bottom of the mouse. This ball rotates when the user moves the mouse across the mouse pad. When the mouse moves across the mouse pad, the ball moves rollers within the housing of the mouse and an electronic code representing the movement of the ball travels by cable to the computer box. A microprocessor uses this code to move a cursor called a pointer in the same way as the mouse moves.

In a more detailed description of the mouse, the ball inside the mouse touches the desktop and rolls when the mouse moves. The two rollers inside the mouse touch the ball. One of the rollers is oriented so that it detects motion in the X direction, and the other is oriented 90 degrees to the first roller so it detects motion in the Y direction. When the ball rotates, one or both of these rollers rotate as well. The rollers each connect to a shaft, and the shaft spins a disk with holes in it. When a roller rolls, its shaft and disk spin. On either side of the disk there is an infrared LED and an infrared sensor. The holes in the disk break the beam of light coming from the LED so that the infrared sensor sees pulses of light. The rate of the pulsing is directly related to the speed of the mouse and the distance it travels. An on-board processor chip reads the pulses from the infrared sensors and turns them into binary data that the computer can understand. The chip sends the binary data to the computer through the mouse's cord. In this optomechanical arrangement, the disk moves mechanically, and an optical system counts pulses of light. On this mouse, the ball is 21 mm in diameter. The roller is 7 mm in diameter. The encoding disk has 36 holes. So if the mouse moves 25.4 mm (1 inch), the encoder chip detects 41 pulses of light. Each encoder disk has two infrared LEDs and two infrared sensors, one on each side of the disk (so there are four LED/sensor pairs inside a mouse). This arrangement allows the processor to detect the disk's direction of rotation. There can be a piece of plastic with a small, precisely located hole that sits between the encoder disk and each infrared sensor. Note that the piece of plastic is between the infrared sensor (red) and the encoding disk. This piece of plastic provides a window through which the infrared sensor can “see.” The window on one side of the disk is located slightly higher than it is on the other—one-half the height of one of the holes in the encoder disk, to be exact. That difference causes the two infrared sensors to see pulses of light at slightly different times. There are times when one of the sensors will see a pulse of light when the other does not, and vice versa.

On the upper surface of a mouse device are one, two or more buttons. The different computer brands may have a different numbers of buttons for their mouse devices. Each button may represent a different action to the computer. A mouse with two or more buttons is generally designed for right-handed use. However, the mouse's control software usually enables the user to reverse the actions of the buttons so that the mouse can be used with the left hand.

To move the insertion point, the user moves the mouse to position the pointer in the new location. The user then presses a mouse button and releases it. This action is known as a clicking the mouse. To give a command, the user moves the mouse so that the pointer travels to an image on the monitor screen that represents that command. These images may resemble push buttons, or they may be tiny pictures called icons. The main goal of any mouse is to translate the motion of your hand into signals that the computer can use. Optical mice and track balls are also known to the art.

A joystick is another input device that outputs data in two axes. Joysticks have a shaft which can be gripped at one end by a user and pivoted about a fixed point in (at least) a two dimensional (X and Y) space. Coupled to the other end of the shaft is some sort of control system, which is operable to convert movement of the shaft in the space into electrical signals.

Many times the user may want to perform operation in connection with the creation of a chart or graph. The user may not want to generate a full table but may want to draw straight lines to help better convey the information. Current methods provide software features that enable user to generate these straight lines in a vertical or horizontal direction. However, these packages have prepared functions that may not meet the specific need that the user has at that time. At the present time, there are no hardware devices that are available to efficiently assist the user in generating straight lines. Currently, the user has to rely on his or her own manual dexterity in order to generate straight lines.

Solutions to this problem usually involve software that is specific to an application that enables you to create straight lines by connecting two points or by dragging a line from a starting location. This solution is insufficient because it is limited to applications that contain this functionality and is more complicated than necessary. This problem would be better solved on the hardware side of the problem.

There remains a need for a hardware mechanism that will enable a user to generate an exact vertical or horizontal motion with a dual-axis input device.

### SUMMARY OF THE INVENTION

It is an objective of the present invention to provide a mechanism that enables the user of a computer input device to generate straight lines using the user's dexterity.

It is a second objective of the present invention to provide a computer input device that has a mechanical means which enables a user to generate disable on of the axis in order to generate a straight line on another axis.

It is a third objective of the present invention to provide mechanism that when activated transmits to the computer only information from one axis.

The present invention solves the problem of moving a dual axis input device in perfectly straight lines either horizontally or vertically across a display area. The mechanism in the present invention, is designed such that when desired by the user, would ignore input to either the X axis or the Y axis of a dual-axis input device therefore enabling the device to move solely in perfectly straight horizontal or vertical lines, despite inconsistent movement by the user. This technology is best suited for peripheral devices such as a computer mouse or a joystick, but would be beneficial in any dual-axis device. By implementing this invention on a physical hardware input device, perfectly straight movement could be attained regardless of what is interfacing with the peripheral device.

The present invention works differently depending the type of input device. In the basic implementation in a computer mouse, the ball inside the mouse touches the desktop and rolls when the mouse moves. Two rollers inside the mouse touch the ball. One of the rollers is oriented so that it detects motion in the X (horizontal) direction, and the other roller is oriented 90 degrees to the first roller so that it detects motion in the Y (vertical) direction. When the ball rotates, one or both of these rollers rotates as well. The rollers each connect to a shaft and the shaft spins a disk with holes in it. When a roller rolls, its shaft and disk spin. On either side of the disk there is an infrared LED and an infrared sensor. The holes in the disk break the beam and the distance it travels. An on-board processor chip reads the pulses from the infrared sensors and turns them into binary data that the computer can interpret.

The present invention is a mechanism such as a toggle switch that, for instance, would prevent the disk for either the X or Y axis from spinning or turning off the associated infrared sensor, this ensuring that the mouse sent data reporting that it was traveling either in a perfectly horizontal or vertical line.

Mechanisms on other alternate dual-axis input devices would be created using similar methods depending on the device.

### DESCRIPTION OF THE DRAWINGS

FIG. 1 is a conventional computing device used that can be used to transmit and receive electronic messages via a computer network.

FIG. 2 is a cross-sectional view of a computer mouse having the components of a ball, driven rollers, and a contact roller.

FIG. 3 is a side view, partly in cross section, of a rotation detector means for a computer mouse apparatus.

FIG. 4 is an illustration of a neutral position switching mechanism that can be incorporated into a Dual-Axis Input Device in accordance with the present invention.

FIG. 5 is an illustration of a switching mechanism positioned such that light from one axis of a Dual-Axis Input Device is inhibited in accordance with the present invention.

FIG. 6 is an illustration of a switching mechanism positioned such that light from one axis of a Dual-Axis Input Device is inhibited in accordance with the present invention.

FIG. 7a is an illustration of an implementation of a multiple position switching mechanism incorporating a shield component attached to the switching mechanism.

FIG. 7b is an illustration of an implementation of the multiple positions switching mechanism shield light from one axis of the dual-axis input device.

FIG. 7c is an illustration of an alternate implementation of the multiple positions switching mechanism shield light from one axis of the dual-axis input device.

FIG. 8 is a side view of the implementation of the multiple positions switching mechanism incorporating the shield component attached to the switching mechanism.

FIG. 9a is an illustration of an implementation of a switching mechanism incorporating a multiple position switch on a mouse input device.

FIG. 9b is an illustration of an implementation of a switching mechanism incorporating a multiple position switch on a mouse input device positioned such that one axis of a Dual-Axis Input Device is inhibited in accordance with the present invention.

FIG. 9c is an illustration of an implementation of a switching mechanism incorporating a multiple position switch on a mouse input device positioned in an alternate position such that one axis of a Dual-Axis Input Device is inhibited in accordance with the present invention.

FIG. 10 is an illustration of a switching mechanism incorporating a set of buttons for selectively inhibiting one axis of a Dual-Axis Input device in accordance with the present invention.

### DETAILED DESCRIPTION OF THE INVENTION

For purposes of the description of the invention, a computer mouse input device will be used. This input device is illustration purposes and the description of the invention can be implemented in other dual axis input devices.

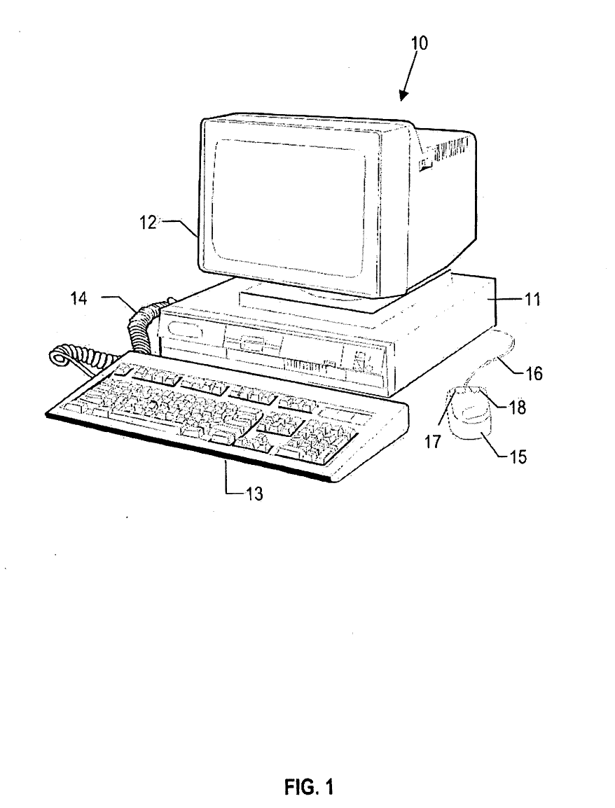

With reference now to FIG. 1, there is depicted a pictorial representation of computing device 10 in which a computer mouse may be incorporated to facilitate the communication of a user with the computing device 10. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention.. Upon reference to the foregoing, those skilled in the art will appreciate that data processing system 10 may be implemented utilizing a personal computer.

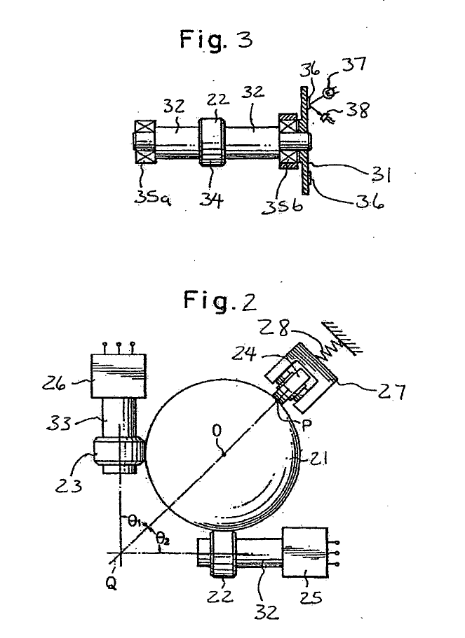

As previously mentioned, a computer mouse is an input device that enables a user to input information to the computer. The mouse comprises several components, which include: a ball, two rollers, a shaft, a disk, and an infrared LED and an infrared sensor. FIG. 2 provides a clear view of the basic mouse design. As shown, ball 21, the two driven rollers 22, 23 and the contact roller 24, which are arranged in an assembled position. The two driven rollers 22, 23 are held and positioned by the first and second driven roller holder sections, so that the axis of the two driven rollers 22, 23 extend perpendicularly with each other. The contact roller 24 is held in contact with the ball 21 and positioned across the ball 21 in opposite relation to the two driven rollers.22, 23. The contact roller 24 serves to transmit power reliably between the ball 21 and the driven rollers 22, 23. The contact roller 24 is freely rotatable with rotation of the ball 21 and resiliently urges the ball 21 against the driven rollers 22, 23. The contact roller 24 is disposed with respect to the ball 21 and the driven rollers 22, 23 such that a straight line Q passing through the point P of contact between the ball 21 and the contact roller 24 and the center O of rotation of the ball 21 intersects the axes of the drive rollers 22, 23 at about 45 degrees (.theta..sub.1, .theta..sub.2) for equalizing the pressure of contact between the ball 21 and one of the driven rollers 22, 23 to the pressure of contact between the ball 21 and the other driven roller 22, 23. Therefore, the angles θ₁.theta..sub.1, theta. θ₂.sub.2 are designed to be equal to each other.

The two driven rollers 22, 23 are individually rotated by the rotation of the ball 21, and directions and angles of rotation of the driven rollers 22, 23 are detected by the rotation detector means such as the encoders 25, 26 associated respectively with the driven rollers 22. The state of rotation of the ball 21 can therefore be detected as components in the X- and Y-axis directions.

FIG. 3 shows a rotation detector means according to another embodiment. The drive roller 22 comprises a rotatable shaft 32, a roller section 34 integrally formed with the rotatable shaft 32 at a substantially central position, and bearings 35a, 35b mounted on opposite ends of the rotatable shaft 32. The encoder 25, 26 comprises an encoder case, a slider support connected to one end of the rotatable shaft 32 for rotation with the driven roller 22, a slider attached to the slider support, a pattern base plate positioned by the encoder case in confronting relation to the slider, and an attachment plate securely attaching the pattern base plate to the encoder case. A rotatable disk 31 is concentrically attached to one end of the rotatable shaft 32, 33 of the driven roller 22, and has a plurality of reflectors 36 are attached to an outer peripheral surface of the disk 31 and spaced at equal intervals in the peripheral direction. A pair of light-emitting element 37 and photodetector 38 is disposed in confronting relation to the reflectors 36. The reflectors 36 reflect a beam of light emitted from the light-emitting element 37. Intermittent light reflections are detected by the photodetector 38 and then counted for detecting the amount of rotation of the driven roller 22.

In the method of the present invention, if the user desires to generate a straight vertical or horizontal line, the user can activate the input device to disable inputs from the axis that is not desired by the user. Activation can be by toggling a switch on the input device. For example, if the input device is a computer mouse, a move of a switch on the mouse to a left position would activate the mouse to the user's desire to generate a straight line. This toggle would also inhibit information from one of the axis. After the user has completed the generation of the straight line, a movement of the switch to a neutral (initial position) would deactivate the line drawing function of the input device.

FIGS. 4, 5 and 6 illustrate means to inhibit light from one of the axis by stopping power to the light source for that axis. In an example, FIG. 4 illustrates light source means 40 and 41 for the X and Y-axis respectively. Each source supplies light via the LEDs 42 and 43 to disks. As previously discussed, the holes in the disk break the beam of light coming from the LEDs so that the infrared sensor sees pulses of light. The rate of the pulsing is directly related to the speed of the mouse and the distance it travels. The present invention would incorporate a switching mechanism 46 that is tied to a ground 47. Contact points on both light sources would enable to the switch contact 48 to establish contact with each light as desired by the user. When the switching contact point contacts a light source connect, an electrical short would occur. This short would cause the current normally going to the LED to go to ground via the switching mechanism. As a result, no power would go to the LED and no light would go from the LED. The computer would not see any coordinates from that axis, thereby creating a line having only coordinates from one axis.

FIG. 5 gives an illustration of the switching mechanism of the present invention in which the horizontal axis is inhibited. Contact 46 connects to the power connection for LED 42. A short is created and no power goes to light the LED. However, light from the LED source 41 continues to power LED 43, which generates Y-axis information as desired by the user.

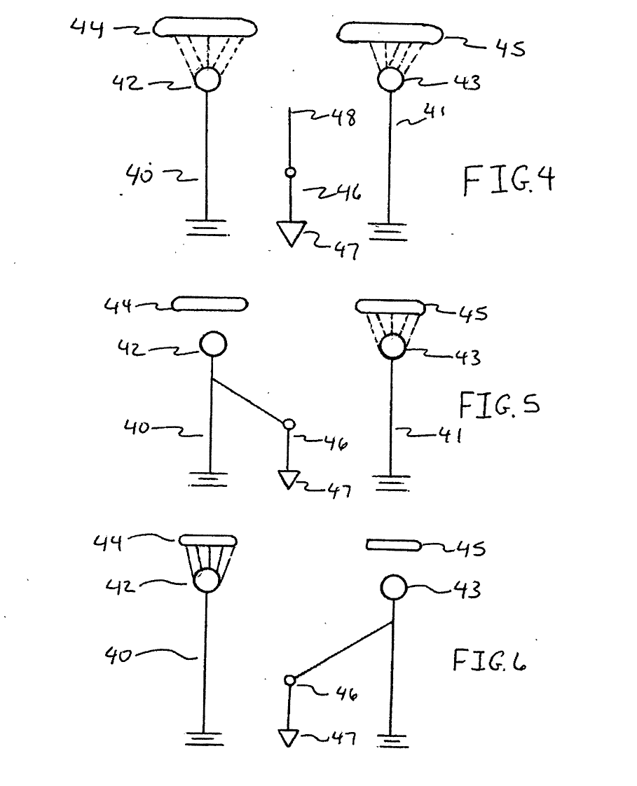

FIG. 6 gives an illustration of the switching mechanism of the present invention in which the vertical axis is inhibited. Contact 46 connects to the power connection for LED 43. A short is created and no power goes to light the LED. However, light from the LED source 40 continues to power LED 42, which generates X-axis information as desired by the user.

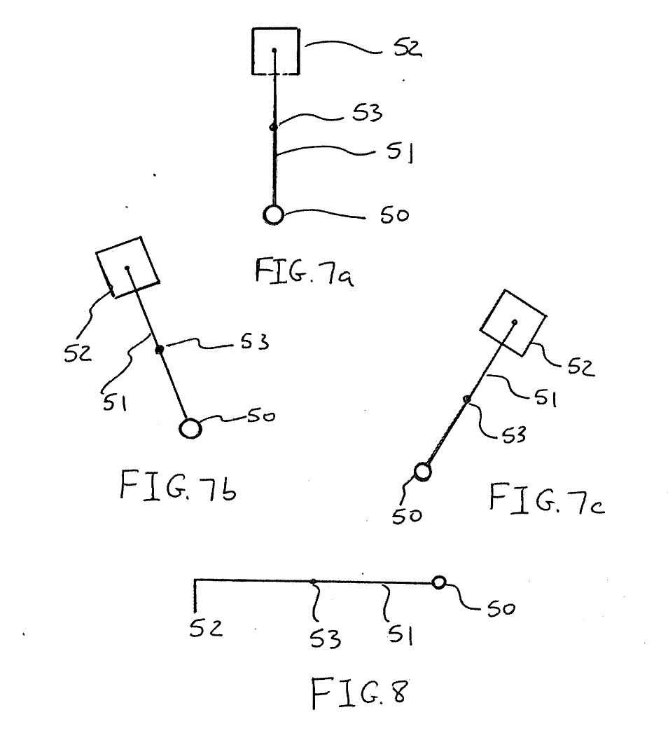

The deactivation could be implemented in several ways and would depend on the actual input device. One approach to disabling inputs from one axis is to stop power to the LED producing the light for one of the axis as indicated in FIGS. 4, 5 and 6. FIGS. 7a, 7b and 7c illustrate implementations of a multiple position switching mechanism incorporating a shield component attached to the switching mechanism. In this approach, a mechanical shield would block the light from one of the axes. FIG. 7a shows the switch in a neutral position. As shown, this mechanism comprises a button 50 attached to a rod 51, which is attached to a shield 52. The rod pivots around a pivot point 53. FIG. 8 is a side view of the implementation of the multiple positions switching mechanism incorporating the shield component attached to the switching mechanism. As shown, the shield 52 extends downward from the rod 51 such that the shield will block the light transmitting axis information to the computer source. FIGS. 7b and 7c are different positions that will be implemented to selectively inhibit information from one axis. FIG. 7b could be the position to inhibit the vertical axis information. FIG. 7c could be the position to inhibit the horizontal axis information.

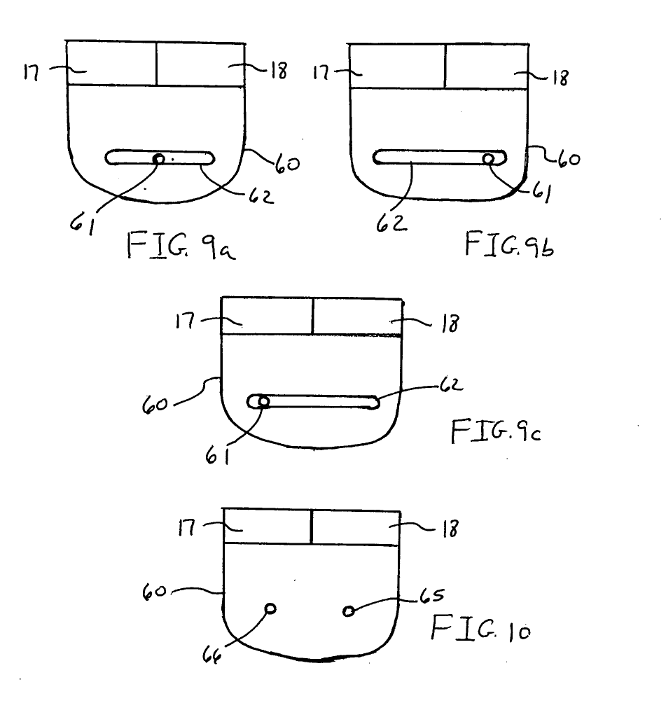

FIGS. 9a, 9b and 9c are illustrations of an implementation of a switching mechanism incorporating a multiple position switch on a mouse input device. This implementation can be for the approach of FIGS. 4, 5, and 6 or FIGS. 7a, 7b, or 7c. As previously shown, the mouse 60 has left and right buttons 17 and 18. Also shown in the switching button 61 inside a groove 62. Referring to FIGS. 4, 5 and 6, the position of the switch in FIG. 9a would correspond to the neutral position of FIG. 4. FIG. 9b could correspond to the position of the switch in FIG. 6. FIG. 9c could correspond to the position of the switch in FIG. 5. Referring to FIGS. 7a, 7b and 7c, the position of the switch in FIG. 9a would correspond to the neutral position of the switch in FIG. 7a. FIG. 9b could correspond to the position of the switch in FIG. 7b. FIG. 9c could correspond to the position of the switch in FIG. 7c.

Yet another approach would be to turn off the sensor for a particular axis. In addition to these implementations, other implementations can be available based on the design of the input devices.

FIG. 10 is an illustration of a switching mechanism incorporating a set of buttons for selectively inhibiting one axis of a Dual-Axis Input device in accordance with the present invention. Each button 65 and 66 could control one of the axes. Each button could have two positions. Depressing the button would inhibit information from the corresponding axis. Depressing the button a second time would restore the button to an initial neutral position, which enables the transmission of information from that axis.

With regard to other input devices, turning off the X or Y-axis for a mechanical trackball can be accomplished in similar manners to that taught above with reference to a mouse. That is, the spinning disk, the source or the sensor can be disabled.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A dual-axis input device connected to a computing source for generating exact vertical or horizontal motion as desired by a user comprising:
a component that generates X-axis information in the input device in response to movement of the input device by the user;
a component that generates Y-axis information in the input device in response to movement of the input device by the user;
a transmitting mechanism that transmits X-axis and Y-axis information to the computing source; and
an axis inhibitor capable of selectively inhibiting information from one of the X or Y axis and thereby transmitting information from only one of the X or Y axis.

2. The device as described in claim 1 wherein said axis inhibitor is a multiple position switch.

3. The device as described in claim 1 wherein said axis inhibitor has the capability to inhibit power form a power source to a selected axis information-generating component.

4. The device as described in claim 1 wherein said X-axis information generating component, said Y-axis generating component, said transmitting mechanism and said axis information inhibitor are incorporated into a computer mouse input device.

5. The device as described in claim 1 wherein said X-axis information generating component, said Y-axis generating component, said transmitting mechanism and said axis information inhibitor are incorporated into a joystick input device.

6. The device as described in claim 1 wherein said X-axis information generating component, said Y-axis generating component, said transmitting mechanism and said axis information inhibitor are incorporated into a track ball input device.

7. The device as described in claim 1 wherein said X-axis information generating component, said Y-axis generating component, said transmitting mechanism and said axis information inhibitor are incorporated wobble plate input device.

8. The device as described in claim 4 wherein the computer mouse input device is an optical mouse input device.

9. The device as described in claim 1 wherein said inhibitor has the capability to shield light transmitting axis information emitted from a selected axis such that the light carrying information does not reach the computing source.

10. The device as described in claim 1 wherein said axis inhibitor further comprises a button on the device for selecting the X-axis or Y-axis information.

11. The device as described in claim 1 wherein said axis inhibitor further comprises a plurality of buttons on the input device for selecting the X-axis or Y-axis to inhibit.
